(19) United States
(12) Patent Application Publication
(10) Pub. No.: US 2010/0222923 A1
(43) Pub. Date: Sep. 2, 2010

(54) Device amd method for teaching work delivery position to robot

(75) Inventor: Kazuyuki Matsumura, Tokyo (JP)

Correspondence Address: BACON & THOMAS, PLLC, 625 SLATERS LANE, FOURTH FLOOR, ALEXANDRIA, VA, 22314-1176, US

(73) Assignee: Hirata Corporation, TOKYO (JP)

(21) Appl. No.: 11/919,208

(22) PCT Filed: Apr. 27, 2005
(86) PCT No.: PCT/JP2005/007978

§ 371 Date: Oct. 25, 2007

(51) Int. Cl. G06F 19/00

(52) U.S. Cl. 700/245

(57) ABSTRACT

[PROBLEMS] To provide a device and a method for teaching a work delivery position to a robot capable of teaching to the robot at low cost in a short time.

[MEANS FOR SOLVING PROBLEMS] This device for teaching the work delivery position to the robot teaches, to the robot beforehand, the work delivery position where the center position of the work is not deviated when the work is delivered between a movable side robot hand (2) and a fixed side work loading table (8). The device comprises a first tool (6) fitted to the robot hand (2) and indicating the center position of the work when a movable side work holding means holds the work a second tool (13) fitted to the work loading table (8) and indicating the center position of the work when a fixed side work holding means holds the work on the work loading table (8), and a teaching means teaching, to a robot controller, the position of the robot hand (2) when the center position of the work indicated by the first tool (6) is aligned with the center position of the work indicated by the second tool (13).

### TECHNICAL FIELD

The present invention relates to an apparatus and method for teaching a workpiece transfer position to a robot, used to teach the robot beforehand a workpiece transfer position at which center misalignment of the workpiece does not occur in transfer of the workpiece between apparatuses each having a workpiece-holding means for holding the workpiece at the circumference, and particularly to such an apparatus and method which can implement inexpensive teaching and can carry out teaching in a short time.

### BACKGROUND ART

In transfer of a circular substrate; for example, a wafer, between apparatuses each having a holding means of a so-called edge clamp type for fixedly holding the wafer at the circumference, center misalignment of the wafer causes imposition of stress on the wafer from a holding portion of the holding means, involving the risk of breakage of the wafer. Therefore, in order to prevent center misalignment of a wafer in such transfer of the wafer, a control unit of the movable-side apparatus (robot) must be taught correctly a wafer transfer position where the wafer is transferred from the movable-side apparatus (robot) to the wafer-holding position of a stationary-side apparatus.

Conventionally, in order to achieve proper transfer of a wafer without involvement of center misalignment of the wafer in transfer of the wafer between a hand of a robot and a wafer table or the like of a wafer-processing apparatus, there have been proposed various apparatuses and methods for teaching the wafer transfer position to the robot. Such an apparatus and method is disclosed in Japanese Saikohyo (PCT) Patent Publication No. WO2003/022534 (Patent Document 1). Most of such conventional apparatuses and methods employ a sensor, an image pickup means, or the like to detect a position. Therefore, teaching consumes much time, and teaching apparatuses become expensive.

Patent Document 1: Japanese Saikohyo (PCT) Patent Publication No. WO2003/022534
Patent Document 2: Japanese Patent Application Laid-Open (kokai) No. 2003-218186

### DISCLOSURE OF THE INVENTION

### Problems to be Solved by the Invention

An object of the present invention is to solve the above-mentioned problems in the conventional apparatuses and methods for teaching a workpiece transfer position to a robot and to provide an apparatus and method for teaching a workpiece transfer position to a robot which can implement inexpensive teaching without use of a sensor, an image pickup means, or the like and can carry out teaching in a short time.

### Means for Solving the Problems

To achieve the above object, the present invention provides the following apparatus and method for teaching a workpiece transfer position to a robot.

The apparatus for teaching a workpiece transfer position to a robot is used to teach the robot beforehand a workpiece transfer position at which center misalignment of a workspiece does not occur in transfer of the workpiece between a movable-side robot hand having workpiece-holding means for holding the workpiece at a circumference and a stationary-side workpiece table having workpiece-holding means for holding the workpiece at the circumference. The apparatus comprises a first jig to be attached to the robot hand and adapted to indicate a position of the center of the workpiece at the time of the movable-side workpiece-holding means holding the workpiece; a second jig to be attached to the workpiece table and adapted to indicate a position of the center of the workpiece at the time of the stationary-side workpiece-holding means holding the workpiece on the workpiece table; and teaching means for teaching a control unit of the robot a position of the robot hand at the time when the position of the center of the workpiece indicated by the first jig is aligned with the position of the center of the workpiece indicated by the second jig.

The apparatus for teaching a workpiece transfer position to a robot is configured as mentioned above and comprises the first jig, the second jig, and the teaching means for teaching the control unit of the robot a position of the robot hand at the time when the position of the center of the workpiece indicated by the first jig is aligned with the position of the center of the workpiece indicated by the second jig. Therefore, the present invention can provide an apparatus for teaching a workpiece transfer position to a robot which can implement inexpensive teaching without use of a sensor, an image pickup means, or the like and can carry out teaching in a short time.

According to a preferred embodiment of the present invention, in the apparatus for teaching a workpiece transfer position to a robot, the first jig has a recess or a projection formed at a position indicative of the position of the center of the workpiece, and the second jig has a projection or a recess formed at a position indicative of the position of the center of the workpiece.

The above configuration facilitates alignment between the position of the center of the workpiece indicated by the first jig and the position of the center of the workpiece indicated by the second jig and enables provision of an apparatus for teaching a workpiece transfer position to a robot which can implement less expensive teaching and can carry out teaching in a shorter time.

According to another preferred embodiment of the present invention, the apparatus for teaching a workpiece transfer position to a robot further comprises a first auxiliary jig. In the apparatus, the first auxiliary jig has the same diameter as that of the workpiece and has a first auxiliary projection or a first auxiliary recess formed at its center, wherein the position of the movable-side workpiece-holding means can be adjusted so as to hold the first auxiliary jig in a condition in which the first auxiliary projection or the first auxiliary recess is fitted to or aligned with the recess or projection of the first jig attached to the robot hand.

By virtue of the above configuration, the position of the center of a workpiece at the time of the workpiece-holding means on the movable side (on the robot-hand side) holding the circumference of the workpiece can be easily aligned with the position of the recess or projection of the first jig, whereby the center of the workpiece can be fixed accurately at the position of the recess or projection.

The method for teaching a workpiece transfer position to a robot is used to teach the robot beforehand a workpiece transfer position at which center misalignment of a workpiece does not occur in transfer of the workpiece between a movable-side robot hand having workpiece-holding means for holding the workpiece at a circumference and a stationary-side workpiece table having workpiece-holding means for holding the workpiece at the circumference; uses a first jig to be attached to the robot hand and adapted to indicate a position of the center of the workpiece at the time of the movable-side workpiece-holding means holding the workpiece, and a second jig to be attached to the workpiece table and adapted to indicate a position of the center of the workpiece at the time of the stationary-side workpiece-holding means holding the workpiece on the workpiece table; and teaches a control unit of the robot a position of the robot hand at the time when the position of the center of the workpiece indicated by the first jig is aligned with the position of the center of the workpiece indicated by the second jig.

The method for teaching a workpiece transfer position to a robot is configured as mentioned above; uses the first jig and the second jig; and teaches the control unit of the robot a position of the robot hand at the time when the position of the center of the workpiece indicated by the first jig is aligned with the position of the center of the workpiece indicated by the second jig. Therefore, the present invention can provide a method for teaching a workpiece transfer position to a robot which can implement inexpensive teaching without use of a sensor, an image pickup means, or the like and can carry out teaching in a short time.

### EFFECTS OF THE INVENTION

As mentioned above, the apparatus for teaching a workpiece transfer position to a robot of the present invention comprises the first jig, the second jig, and the teaching means for teaching the control unit of the robot a position of the robot hand at the time when the position of the center of the workpiece indicated by the first jig is aligned with the position of the center of the workpiece indicated by the second jig. Therefore, the present invention can provide an apparatus for teaching a workpiece transfer position to a robot which can implement inexpensive teaching without use of a sensor, an image pickup means, or the like and can carry out teaching in a short time.

Also, use of the apparatus can provide a method for teaching a workpiece transfer position to a robot which can implement inexpensive teaching and can carry out teaching in a short time.

### BRIEF DESCRIPTION OF THE DRAWINGS

FIG. 1 is a perspective view of an apparatus for teaching a workpiece transfer position to a robot of the present embodiment.

FIG. 2 is a perspective view showing a state in which the apparatus for teaching a workpiece transfer position to a robot carries out teaching.

FIG. 3 is a view showing a relation among a first jig, a first auxiliary jig, and a hand of the robot, the jigs of which are used to positionally adjust a workpiece-holding means of the hand of the robot.

FIG. 4 is a view similar to FIG. 3, showing a state in which the first jig is attached to the hand of the robot.

FIG. 5 is a view similar to FIG. 4, showing a state in which the first auxiliary jig is held by the workpiece-holding means of the hand of the robot.

FIG. 6 is a view showing an initial state of a stationary-side apparatus.

FIG. 7 is a rear view of a cover used to cover a central depression of the stationary-side apparatus.

FIG. 8 is a partial, side sectional view of the stationary-side apparatus in a state in which the cover covers the central depression of the stationary-side apparatus.

FIG. 9 is a view showing a state of FIG. 8 in which a second jig is removed, as well as a relation between the second jig and the stationary-side apparatus.

FIG. 10 is a view similar to FIG. 9, showing a state in which the second jig is fixedly fitted into a recess formed at a central portion of a workpiece table of the stationary-side apparatus.

FIG. 11 is a view showing an ordinary state of the stationary-side apparatus in which the second jig is removed from a state of FIG. 10 and in which the central depression of the workpiece table is covered with the cover.

### DESCRIPTION OF REFERENCE NUMERALS

1: apparatus for teaching workpiece transfer position to robot; 2: robot hand; 3: blade; 4: seat; 5: hole; 6: first jig; 7: stationary-side apparatus; 8: workpiece table; 9: recess; 10: roller; 11: pin; 12: maximum-diameter portion; 13: second jig; 14: annular projection; 15: central depression; 16: protrusion; 17: air outlet; 18: cover; 19: bolt hole; 20: first auxiliary jig; 21: auxiliary hole; 22: clearance; 23: annular recess; 24: bolt

### BEST MODE FOR CARRYING OUT THE INVENTION

An apparatus for teaching a workpiece transfer position to a robot, used to teach the robot beforehand a workpiece transfer position at which center misalignment of a workpiece does not occur in transfer of the workpiece between a movable-side robot hand having workpiece-holding means for holding the workpiece at a circumference and a stationary-side workpiece table having workpiece-holding means for holding the workpiece at the circumference, includes a first jig to be attached to the robot hand and adapted to indicate a position of the center of the workpiece at the time of the movable-side workpiece-holding means holding the workpiece; a second jig to be attached to the workpiece table and adapted to indicate a position of the center of the workpiece at the time of the stationary-side workpiece-holding means holding the workpiece on the workpiece table; and teaching means for teaching a control unit of the robot a position of the robot hand at the time when the position of the center of the workpiece indicated by the first jig is aligned with the position of the center of the workpiece indicated by the second jig.

### EMBODIMENT

Next, an embodiment of the present invention will be described.

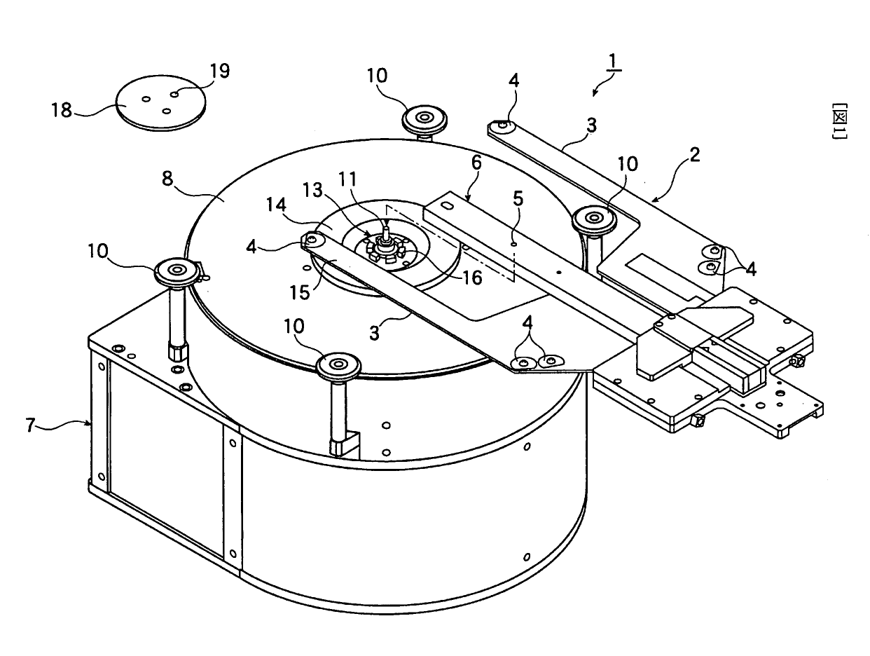

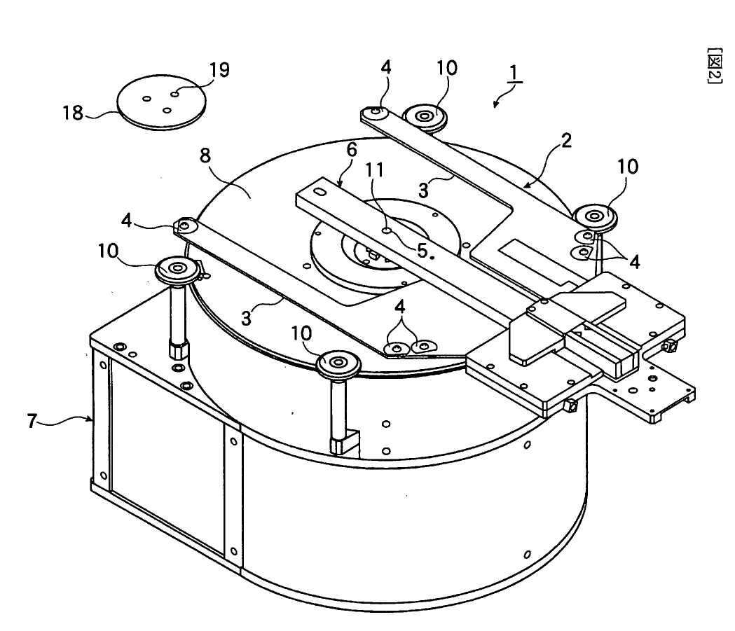

FIG. 1 is a perspective view of an apparatus for teaching a workpiece transfer position to a robot of the present embodiment. FIG. 2 is a perspective view showing a state in which the teaching apparatus carries out teaching.

The apparatus for teaching a workpiece transfer position to a robot of the present embodiment is used in, for example, a semiconductor manufacturing plant, to teach the robot beforehand a workpiece transfer position at which center misalignment of a workpiece does not occur in transfer of the workpiece between a hand of the robot (robot hand) and a workpiece table provided on a stationary-side apparatus. The stationary-side apparatus mentioned in the present embodiment is a pneumatic levitation aligner, but is not limited thereto. The stationary-side apparatus may be a loader/unloader of a processing apparatus.

As shown in FIGS. 1 and 2, the apparatus 1 of the present embodiment for teaching a workpiece transfer position to a robot includes a first jig 6 to be attached to a movable-side robot hand 2; a second jig 13 to be attached to a workpiece table 8 provided on a stationary-side apparatus 7; and an unillustrated electronically configured teaching means.

The first jig 6 is formed from an elongated narrow bar having a rectangular parallelepiped shape; is attached to a proximal end portion of the robot hand 2 at a central position between a pair of blades 3, 3 of the robot hand 2; and has a recess 5 at a position which coincides with the position of the center of a workpiece (not shown) held by a plurality of (two or more; in the present embodiment, one at a distal end portion and two at a proximal end portion, a total of three) claws 4, each having a seat, attached to an upper surface of each of the paired blades 3, 3. The pair of blades 3, 3 and a total of six claws 4 each having a seat constitute a robot-side (movable-side) workpiece-holding means. In the present embodiment, the recess 5 assumes the form of a hole 5, which is a vertically extending through-hole, but is not limited thereto. The recess 5 may assume the form of a blind hole.

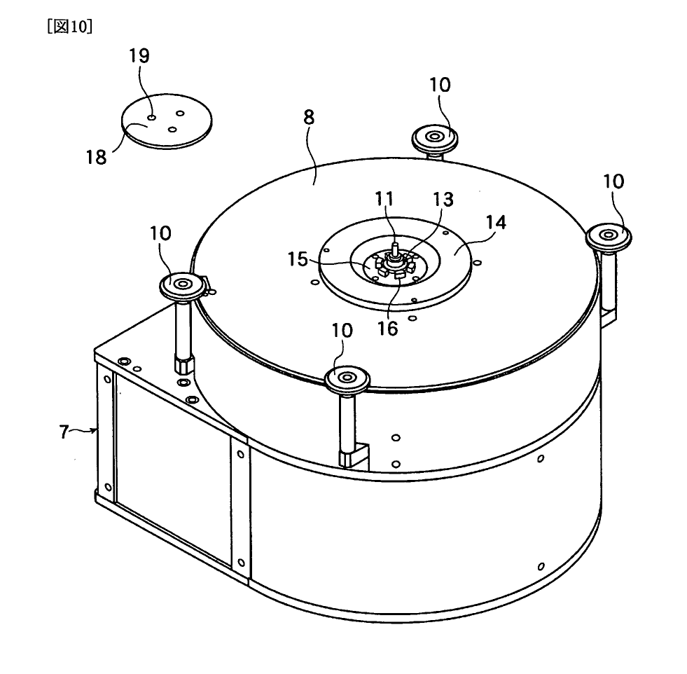

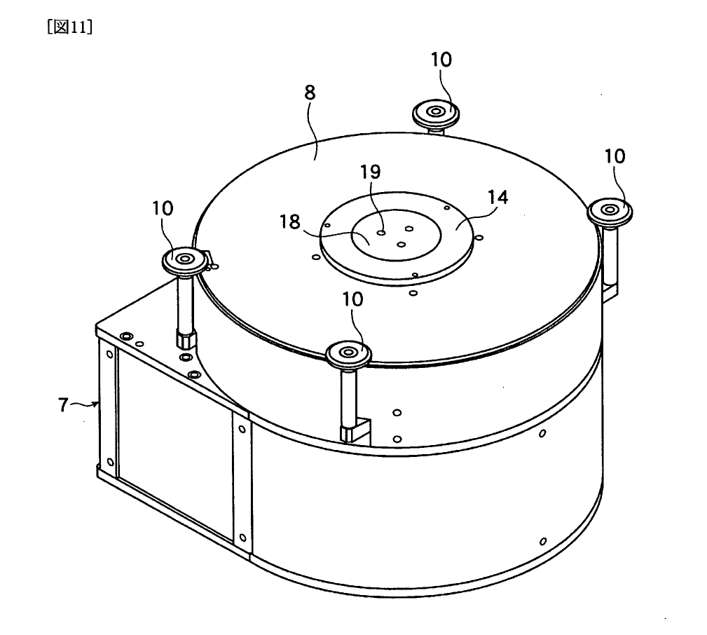

As well shown in FIG. 9, the second jig 13 assumes the form of a pin having a stepped head, and a maximum-diameter portion 12 of the stepped head is fitted into a recess 9 (see FIG. 9) formed at a central portion of the workpiece table 8 of the stationary-side apparatus 7, thereby being fixedly attached to the workpiece table 8. A pin portion (projection) of the second jig 13 is referred to as a pin 11. In a state in which the maximum-diameter portion 12 of the head is fitted to inner walls of protrusions 16, the pin 11 is located at a position which coincides with a position of the center of a workpiece held on the workpiece table 8 by a plurality of (three or more; in the present embodiment, four) rollers 10 (workpiece-centering means) arranged at equal intervals at an outer circumferential portion of the stationary-side apparatus 7. The pin 11 and the maximum-diameter portion 12 of the head of the second jig 13 are accurately concentric with each other.

The stationary-side apparatus 7 is a pneumatic levitation aligner. Air ejected from the surface of the workpiece table 8 supports a wafer horizontally in a noncontact manner, and a plurality of the rollers 10 disposed around the workpiece table 8 center the wafer on the workpiece table 8 and hold the wafer at the position. The recess 9 formed at a central portion of the workpiece table 8 is surrounded by a plurality of the protrusions 16, which are concentrically arranged at equal intervals at the central portion of the workpiece table 8. A plurality of the protrusions 16 are formed in such a manner as to project from a bottom of a central depression 15 surrounded by a tapered wall of an annular projection 14 projecting from the central portion of the workpiece table 8. An air outlet 17 opens at the bottom of the central depression 15 at the center of the recess 9.

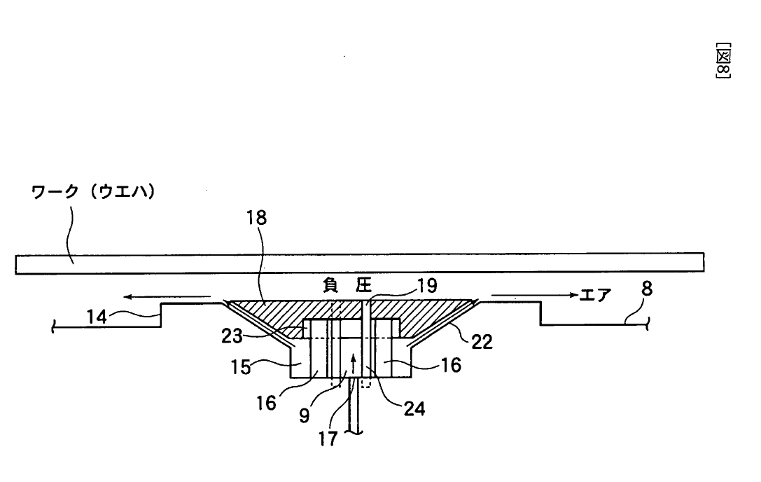

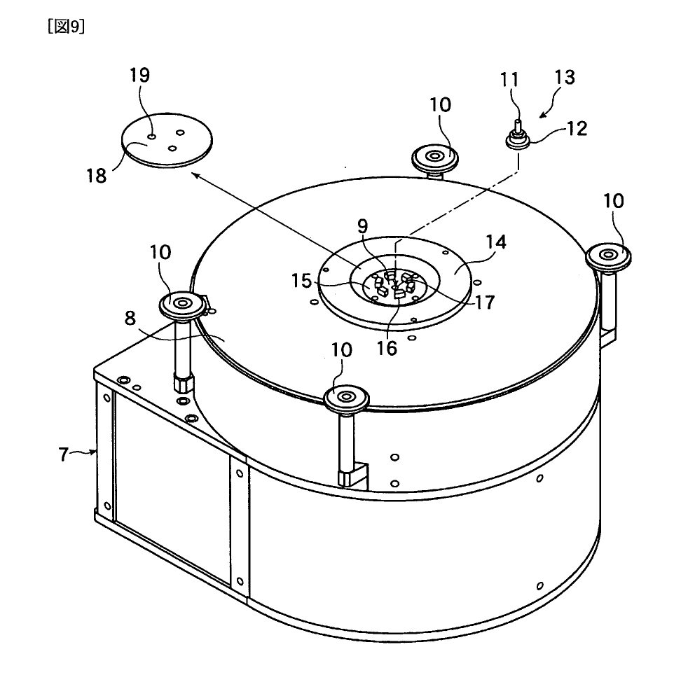

As shown in FIGS. 7 and 8, a cover 18 assumes the form of an inverted trapezoid as viewed laterally and has an annular recess 23 at its bottom. Furthermore, the cover 18 has a plurality of holes 19 for bolting. When the central depression 15 is covered with the cover 18, the protrusions 16 enter the annular recess 23 of the cover 18, thereby supporting the cover 18 from underneath with resultant formation of a small clearance 22 between the cover 18 and the central depression 15. In this condition, the cover 18 is fastened to the central depression 15 by means of bolts 24 extending through the corresponding holes 19. When air is ejected from the air outlet 17, air flows through space between the bolts 24 and through space between the protrusions 16 and is ejected through the small clearance 22 between the cover 18 and the central depression 15. The central depression 15 assumes a tapered form. This is because, as shown in FIG. 8, air ejected from the air outlet 17 is once collected in a space defined by the cover 18 and the central depression 15 and is then ejected at high speed through the narrow clearance toward the outer circumference of the workpiece table 8. A high-speed air flow is formed between the workpiece table 8 and a workpiece, thereby generating negative pressure above the upper surface of the cover 18; i.e., effecting the Bernoulli effect.

The teaching means is electrically configured and connected to a control unit of a robot. The teaching means teaches the control unit of the robot a position of the robot hand 2, as a workpiece transfer position, at the time of the pin 11 of the second jig 13 being fitted into the hole 5 of the first jig 6 as shown in FIG. 2. This completes teaching of the workpiece transfer position to the robot.

Next will be described a process of actually transferring a workpiece between the workpiece table 8 of the stationary-side apparatus 7 and the robot hand 2 having a control unit which has received teaching as mentioned above.

The control unit of the robot which has been taught a workpiece transfer position as mentioned above moves the robot hand 2 actually holding the workpiece to a taught workpiece transfer position (a position where the pin 11 of the second jig 13 is inserted into the hole 5 of the first jig 6; however, in actual transfer of workpiece, these jigs are removed) located above the workpiece table 8. At the same time, air is ejected from the air outlet 17 of the workpiece table 8. Subsequently, the robot hand 2 moves the workpiece to a predetermined level (a level at which the workpiece is held on the workpiece table 8). Simultaneously with a workpiece release operation, the four rollers 10 of the stationary-side apparatus 7 move on the workpiece table 8 in such a mutually approaching manner as to reduce the diameter of a common imaginary circle which the rollers 10 externally contact, thereby carrying out centering of the workpiece. At this time, since the position of the center of the workpiece coincides with the center of the imaginary circle, the workpiece is free from stress from the four rollers 10 and is received accurately by the four rollers 10. After transfer of the workpiece to the four rollers 10 (workpiece-centering means), the robot hand 2 lowers slightly and then retreats from above the workpiece table 8.

On the contrary, in transfer of the workpiece from the stationary-side apparatus 7 to the robot hand 2, the claws 4, each having a seat, of the robot hand 2 hold the workpiece which is centered by the four rollers 10. In the pneumatic levitation aligner of the present embodiment, this moment involves the highest risk of imposing stress on the workpiece. In transfer of the workpiece from the robot hand 2 to the stationary-side apparatus 7, at the point of time when the robot hand 2 begins a workpiece release operation, the four rollers 10 are not required to reach respectively predetermined positions. That is, in the case where transfer is not adversely effected by some difference in timing between start of release on one side and completion of holding on the other side, damage to the workpiece is little. However, in transfer of the workpiece between circumferentially holding mechanisms as in the case of transfer of the workpiece from the stationary-side apparatus 7 to the robot hand 2, timing must be matched between start of release on one side and completion of holding on the other side; thus, center misalignment of workpiece causes imposition of stress on the workpiece.

Therefore, by means of establishing alignment beforehand by the present apparatus between a center position of a workpiece held by one circumferentially holding mechanism and a center position of a workpiece held by the other circumferentially holding mechanism, potential damage to the workpiece can be eliminated.

Here will be described a means and method for easily aligning the position of the center of a workpiece at the time of the workpiece-holding means (a pair of the blades 3, 3 and six claws 4 each having a seat) of the robot hand 2 holding the workpiece, with the position of the hole 5 of the first jig 6, and thereby accurately fixing the center of the workpiece at the position of the hole 5.

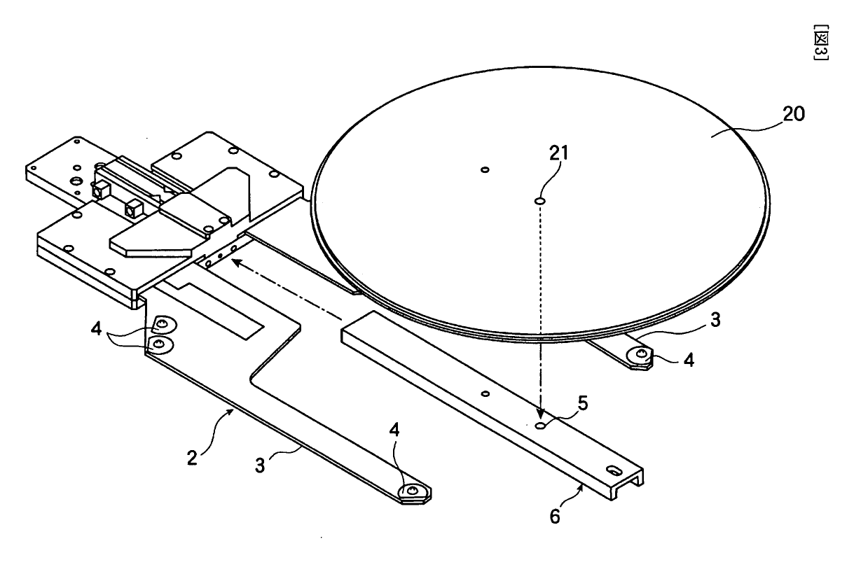

First, a means and method for easily aligning the position of the center of a workpiece at the time of the workpiece-holding means of the robot hand 2 holding the workpiece, with the position of the hole 5 of the first jig 6, and thereby accurately fixing the center of the workpiece at the position of the hole 5 (in other words, a means and method for positioning the center of the workpiece on the robot hand 2) will be described with reference to FIGS. 3 to 5.

The means and method use the first jig 6 and a first auxiliary jig 20 as shown in FIG. 3.

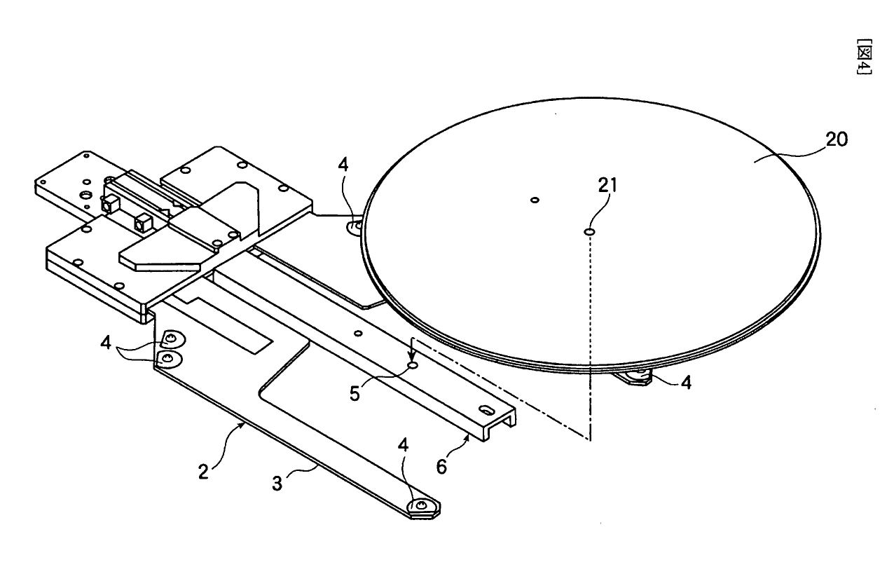

As mentioned previously, the first jig 6 is formed from an elongated narrow bar having a rectangular parallelepiped shape; is attached to a proximal end portion of the robot hand 2 at a central position between a pair of the blades 3, 3 of the robot hand 2 (see FIG. 4); and has the hole 5 formed as a vertically extending through-hole at its longitudinally intermediate position and indicative of a provisional center position of a workpiece at the time of the workpiece being held by the six claws 4, each having a seat, attached to the upper surfaces of the paired blades 3, 3.

As shown in FIG. 3, the first auxiliary jig 20 is formed from a disk having the same diameter as that of the workpiece and has an auxiliary hole (first auxiliary recess) 21 formed at its center. The auxiliary hole 21 can be replaced with an auxiliary pin (first auxiliary projection).

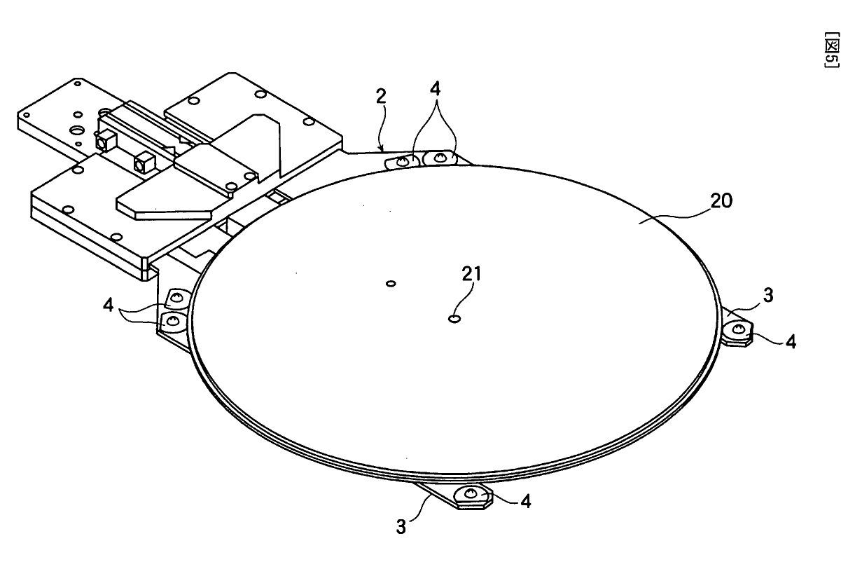

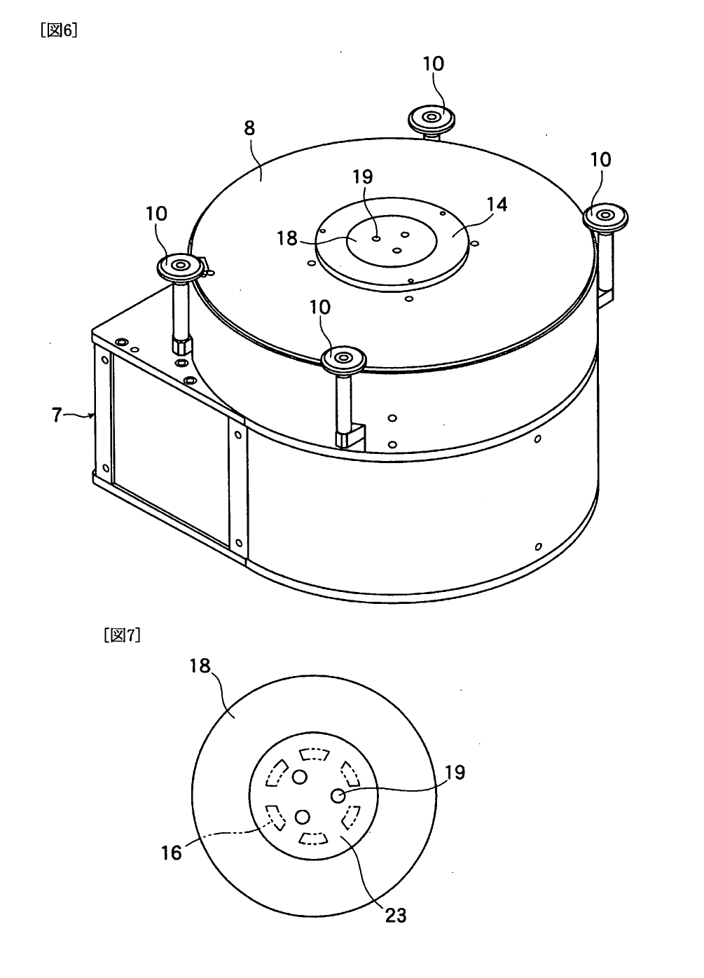

As shown in FIGS. 4 and 5, the thus-formed first auxiliary jig 20 is placed on the first jig 6 and the paired blades 3, 3 while being positioned such that the auxiliary hole 21 is aligned with the hole 5 of the first jig 6 attached to the robot hand 2. In this condition, the workpiece-holding means (composed of the paired blades 3, 3 and the six claws 4 each having a seat) of the robot hand 2 is positionally adjusted so as to hold the circumference of the first auxiliary jig 20. Specifically, the paired blades 3, 3 are moved toward each other, and the six claws 4 each having a seat are positionally adjusted.

When the position (workpiece-holding position) of each of the six claws 4, which each have a seat and hold the circumference of the first auxiliary jig 20, is determined, the paired blades 3, 3 move away from each other to thereby release the first auxiliary jig 20. Subsequently, when the paired blades 3, 3 appropriately approach each other for holding a workpiece, the six claws 4 each having a seat can hold the workpiece at the circumference such that the position of the center of the workpiece coincides with the position of the hole 5 of the first jig 6. The workpiece-holding means of the robot hand 2 shown in FIG. 1 is in a condition in which the workpiece-holding means is positionally adjusted as mentioned above. As mentioned previously, when the robot hand 2 is to actually hold a workpiece, the first jig 6 is removed.

The two claws 4, each having a seat, attached to a proximal end portion of the upper surface of each of the paired blades 3, 3 of the robot hand 2 are provided for holding a workpiece having an orientation flat and are not limited in quantity to two. A single claw 4 may be provided.

Upon completion of positional adjustment of the workpiece-holding means of the robot hand 2 and centering of a workpiece on the robot hand 2 by use of the first jig 6 and the first auxiliary jig 20 as described above, the control unit of the robot becomes ready to be taught a workpiece transfer position by use of the first jig 6 and the second jig 13. The procedure for teaching a workpiece transfer position has already been described with reference to FIGS. 1 and 2.

The stationary-side apparatus 7 shown in FIG. 11 is in an ordinary state ready for transfer of a workpiece in which the second jig 13 is removed from the workpiece table 8 after completion of the operation of teaching the workpiece transfer position to the control unit of the robot, and in which the central depression 15 of the workpiece table 8 is covered with the cover 18.

The apparatus and method for teaching a workpiece transfer position to a robot of the present embodiment is configured as mentioned above and thus yields the following effects.

An apparatus 1 for teaching a workpiece transfer position to a robot includes the first jig 6; the second jig 13; and the teaching means for teaching the control unit of the robot a position of the robot hand 2 at the time of the pin 11 of the second jig 13 being inserted into the hole 5 of the first jig 6. Therefore, the present invention can provide an apparatus for teaching a workpiece transfer position to a robot which can implement inexpensive teaching without use of a sensor, an image pickup means, or the like and can carry out teaching in a short time.

Also, the apparatus for teaching a workpiece transfer position to a robot further includes the first auxiliary jig 20. The first auxiliary jig 20 has the same diameter as that of the workpiece; has the auxiliary hole 21 formed at its center; and enables the workpiece-holding means (movable-side workpiece-holding means; composed of a pair of the blades 3, 3 and six claws 4 each having a seat) of the robot hand 2 to be positionally adjusted so as to hold the circumference of the first auxiliary jig 20 in a condition in which the auxiliary hole 21 is aligned with the hole 5 of the first jig 6 attached to the robot hand 2. This facilitates alignment of the position of the center of a workpiece at the time of the workpiece-holding means of the robot hand 2 holding the workpiece, with the position of the hole 5 of the first jig 6, whereby the center of the workpiece can be fixed accurately at the position of the hole 5.

The present invention is not limited to the above embodiment, but may be embodied in various other forms without departing from the spirit of the invention.

For example, fitting/insertion of the pin (projection) 11 of the second jig 13 into the hole (recess) 5 of the first jig 6 may be modified such that the recess and the projection are replaced with each other. Also, fitting of the maximum-diameter portion 12 of the second jig 13 into the recess 9 formed at a central portion of the workpiece table 8 may be modified such that the recess 9 is replaced with a projection to which a recess formed in the bottom of the maximum-diameter portion 12 is fitted.

1. An apparatus for teaching a workpiece transfer position to a robot, used to teach the robot beforehand a workpiece transfer position at which center misalignment of a workpiece does not occur in transfer of the workpiece between a movable-side robot hand having workpiece-holding means for holding the workpiece at a circumference and a stationary-side workpiece table having workpiece-holding means for holding the workpiece at the circumference, comprising:
a first jig to be attached to the robot hand and adapted to indicate a position of the center of the workpiece at the time of the movable-side workpiece-holding means holding the workpiece;
a second jig to be attached to the workpiece table and adapted to indicate a position of the center of the workpiece at the time of the stationary-side workpiece-holding means holding the workpiece on the workpiece table; and
teaching means for teaching a control unit of the robot a position of the robot hand at the time when the position of the center of the workpiece indicated by the first jig is aligned with the position of the center of the workpiece indicated by the second jig.

2. An apparatus for teaching a workpiece transfer position to a robot according to claim 1, wherein the first jig has a recess or a projection formed at a position indicative of the position of the center of the workpiece.

3. An apparatus for teaching a workpiece transfer position to a robot according to claim 1 or 2, wherein the second jig has a projection or a recess formed at a position indicative of the position of the center of the workpiece.

4. An apparatus for teaching a workpiece transfer position to a robot according to claim 2 or 3, further comprising a first auxiliary jig, wherein:
the first auxiliary jig has the same diameter as that of the workpiece, and has a first auxiliary projection or a first auxiliary recess formed at its center,
wherein, in a condition in which the first auxiliary projection or the first auxiliary recess is fitted to or aligned with the recess or projection of the first jig attached to the robot hand, the position of the movable-side workpiece-holding means can be adjusted such that the first auxiliary jig is held by the movable-side workpiece-holding means.

5. A method for teaching a workpiece transfer position to a robot, used to teach the robot beforehand a workpiece transfer position at which center misalignment of a workpiece does not occur in transfer of the workpiece between a movable-side robot hand having workpiece-holding means for holding the workpiece at a circumference and a stationary-side workpiece table having workpiece-holding means for holding the workpiece at the circumference, using:
a first jig to be attached to the robot hand and adapted to indicate a position of the center of the workpiece at the time of the movable-side workpiece-holding means holding the workpiece, and
a second jig to be attached to the workpiece table and adapted to indicate a position of the center of the workpiece at the time of the stationary-side workpiece-holding means holding the workpiece on the workpiece table; and
teaching a control unit of the robot a position of the robot hand at the time when the position of the center of the workpiece indicated by the first jig is aligned with the position of the center of the workpiece indicated by the second jig.
